(19) United States
(12) Patent Application Publication
(10) Pub. No.: US 2003/0172782 A1
(43) Pub. Date: Sep. 18, 2003

(54) Split socket tool

(76) Inventor: Todd R. Saunders, Spring Lake, MI (US)

Correspondence Address: TODD R. SAUNDERS, 15756 MARGARET AVENUE, SPRING LAKE, MI, 49456, US

(21) Appl. No.: 10/390,827

(22) Filed: Mar. 18, 2003

Related U.S. Application Data
(60) Provisional application No. 60/365,397, filed on Mar. 18, 2002.

(51) Int. Cl. B25B 13/02

(52) U.S. Cl. 81/119

(57) ABSTRACT

Open end wrenches, pliers, locking pliers, and adjustable open end wrenches, each of which include a portion forming an offset split socket for gripping fasteners or the like having a hexagonal shape. The offset split sockets include a transversely extending portion to provide access for applications having limited access.

### CROSS-REFERENCED TO RELATED APPLICATIONS

This application claims the benefit of U.S. Provisional Application No. 60/365,397, entitled TOOLS, filed Mar. 18, 2002, the entire contents of which are incorporated by reference.

### BACKGROUND OF THE INVENTION

Various types of pliers, crescent wrenches, pipe wrenches, open ended wrenches, and the like have been developed to enable a user to torque, for example, threaded fasteners. However, known pliers and the like may not be readily usable in situations wherein access to the fastener is limited.

### SUMMARY OF THE INVENTION

The present invention includes open end wrenches, pliers, locking pliers, and adjustable open end wrenches and adjustable closed end wrenches, each of which include a portion forming an offset split socket for gripping fasteners or the like having a hexagonal shape. The split sockets with or without offsets include a transversely extending portion to provide access for applications having limited access.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 illustrates a locking pliers having offset split socket gripping jaws according to one aspect of the present invention;

FIG. 2 is a side view of the pliers of FIG. 1;

FIG. 3 illustrates another embodiment of the pliers of FIG. 1;

FIG. 4 is a side view of the pliers of FIG. 3;

FIG. 5 is another embodiment of the locking pliers of FIG. 1;

FIG. 6 is a side view of the pliers of FIG. 5;

FIG. 7 illustrates an open end wrench according to another aspect of the present invention;

FIG. 8 illustrates an embodiment of the open end wrench of FIG. 7 in use;

FIG. 9 illustrates an embodiment of the open end wrench of FIG. 7 in use;

FIG. 10 is a perspective view of an open end wrench according to another aspect of the present invention;

FIG. 11 is a perspective view of an open end wrench according to another aspect of the present invention;

FIG. 12 illustrates an open end wrench according to another aspect of the present invention including a swiveling offset split socket;

FIG. 13 is a perspective view of an open end wrench according to another aspect of the present invention;

FIG. 14 illustrates an adjustable open end wrench having an offset split socket according to another aspect of the present invention;

FIG. 15 illustrates an embodiment of the adjustable open end wrench of FIG. 14 in use;

FIG. 16 illustrates an embodiment of the adjustable open end wrench of FIG. 14 in use;

FIG. 17 illustrates a pipe wrench having an offset split socket according to another aspect of the present invention;

FIG. 18 illustrates an embodiment of the pipe wrench of FIG. 17 in use;

FIG. 19 illustrates an embodiment of the pipe wrench of FIG. 17 in use;

FIG. 20 is a perspective view of another embodiment of an adjustable open end wrench according to the present invention;

FIG. 21 is a perspective view of another embodiment of an adjustable open end wrench according to the present invention;

FIG. 22 is a perspective view of another embodiment of an adjustable open end wrench according to the present invention;

FIG. 23 is a perspective view of another embodiment of an adjustable open end wrench according to the present invention;

FIG. 24 is a perspective view of another embodiment of an adjustable wrench according to the present invention including a closed end;

FIG. 25 is a perspective view of another embodiment of an adjustable wrench according to the present invention including a closed end;

FIG. 26 is a perspective view of an adjustable wrench according to another aspect of the present invention;

FIG. 27 is a perspective view of another embodiment of an adjustable wrench according to the present invention including a closed end;

FIG. 28 illustrates a pinch nose pliers having a split socket according to another aspect of the present invention;

FIG. 29 shows an embodiment of the pliers of FIG. 28 in use;

FIG. 30 shows an embodiment of the pliers of FIG. 28 in use;

FIG. 31 is a perspective view of another embodiment of a pliers having an offset split socket;

FIG. 32 is a perspective view of another embodiment of a pliers having an offset split socket;

FIG. 33 is a perspective view of another embodiment of a pliers having an offset split socket;

FIG. 34 is a perspective view of another embodiment of a pliers having an offset split socket;

FIG. 35 is a perspective view of another embodiment of a pliers having an offset split socket;

FIG. 36 is a perspective view of another embodiment of a pliers having an offset split socket;

FIG. 37 is a perspective view of another embodiment of a pliers having an offset split socket;

FIG. 38 is a perspective view of another embodiment of a pliers having an offset split socket;

FIG. 39 is a perspective view of another embodiment of a pliers having an offset split socket;

FIG. 40 is a perspective view of another embodiment of a pliers having an offset split socket;

FIG. 41 is a perspective view of another embodiment of a pliers having an offset split socket;

FIG. 42 is a perspective view of another embodiment of a pliers having an offset split socket;

FIG. 43 illustrates another pliers according to the present invention having an offset split socket jaw portion;

FIG. 44 illustrates an embodiment of the pliers of FIG. 43 in use;

FIG. 45 illustrates an embodiment of the pliers of FIG. 43 in use;

FIG. 46 illustrates another pliers according to the present invention having an offset split socket jaw portion;

FIG. 47 illustrates another pliers according to the present invention having an offset split socket jaw portion;

FIG. 48 illustrates another pliers according to the present invention having an offset split socket jaw portion;

FIG. 49 illustrates another pliers according to the present invention having an offset split socket jaw portion;

FIG. 50 illustrates another pliers according to the present invention having an offset split socket jaw portion;

FIG. 51 illustrates another pliers according to the present invention having an offset split socket jaw portion;

FIG. 52 illustrates another pliers according to the present invention having an offset split socket jaw portion;

FIG. 53 illustrates another pliers according to the present invention having an offset split socket jaw portion;

FIG. 54 is a perspective view of another embodiment of pliers having an offset split socket according to another aspect of the present invention;

FIG. 55 illustrates two embodiments of the pliers of FIG. 54 in use;

FIG. 56 is a perspective view of another embodiment of pliers having an offset split socket according to another aspect of the present invention;

FIG. 57 is a perspective view of another embodiment of pliers having an offset split socket according to another aspect of the present invention;

FIG. 58 is a perspective view of another embodiment of pliers having an offset split socket according to another aspect of the present invention;

FIG. 59 is a perspective view of another embodiment of pliers having an offset split socket according to another aspect of the present invention;

FIG. 60 illustrates an adjustable pliers according to another aspect of the present invention, including an offset split socket;

FIG. 61 illustrates an embodiment of the pliers of FIG. 60 in use;

FIG. 62 illustrates an embodiment of the pliers of FIG. 60 in use;

FIG. 63 is a perspective view of another embodiment of the pliers of FIG. 60;

FIG. 64 is a perspective view of another embodiment of pliers having an offset split socket according to the present invention;

FIG. 65 is a perspective view of another embodiment of pliers having an offset split socket according to the present invention;

FIG. 66 is a perspective view of another embodiment of pliers having an offset split socket according to the present invention;

FIG. 67 is a perspective view of another embodiment of pliers having an offset split socket according to the present invention;

FIG. 68 is a perspective view of another embodiment of pliers having an offset split socket according to the present invention;

FIG. 69 is a perspective view of another embodiment of pliers having an offset split socket according to the present invention;

FIG. 70 is a perspective view of another embodiment of pliers having an offset split socket according to the present invention;

FIG. 71 is a perspective view of another embodiment of pliers having an offset split socket according to the present invention;

FIG. 72 is a perspective view of another embodiment of pliers having an offset split socket according to the present invention;

FIG. 73 is a perspective view of another embodiment of pliers having an offset split socket according to the present invention;

FIG. 74 is a perspective view of another embodiment of pliers having an offset split socket according to the present invention;

FIG. 75 illustrates a locking pliers having an offset split socket according to another aspect of the present invention;

FIG. 76 illustrates an embodiment of the locking pliers of FIG. 75 in use;

FIG. 77 illustrates an embodiment of the locking pliers of FIG. 75 in use

FIG. 78 is a perspective view of a locking pliers according to another aspect of the present invention;

FIG. 79 is a perspective view of a locking pliers according to another aspect of the present invention;

FIG. 80 is a perspective view of a locking pliers according to another aspect of the present invention;

FIG. 81 is a perspective view of a locking pliers according to another aspect of the present invention;

FIG. 82 is a perspective view of a locking pliers according to another aspect of the present invention;

FIG. 83 is a perspective view of a locking pliers according to another aspect of the present invention;

FIG. 84 is a perspective view of a locking pliers according to another aspect of the present invention; and

FIG. 85 is a perspective view of a locking pliers according to another aspect of the present invention.

### DETAILED DESCRIPTION OF PREFERRED EMBODIMENT

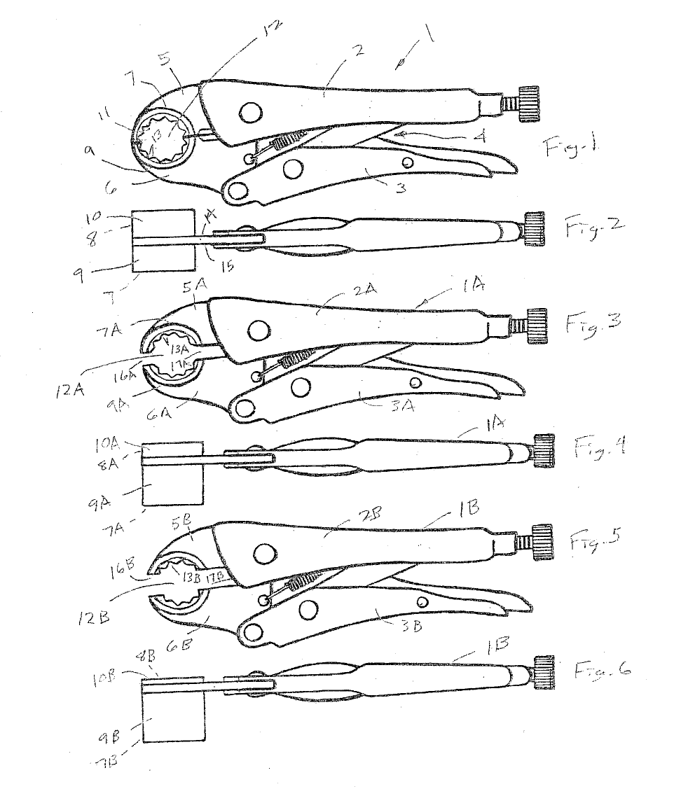

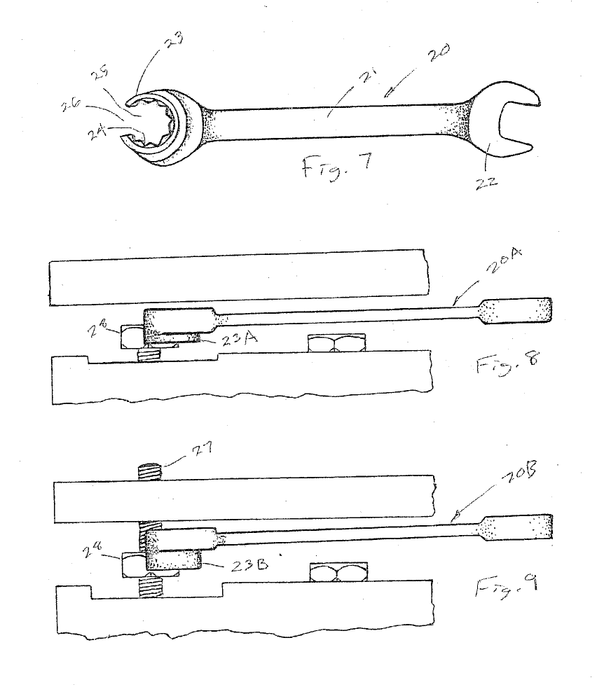

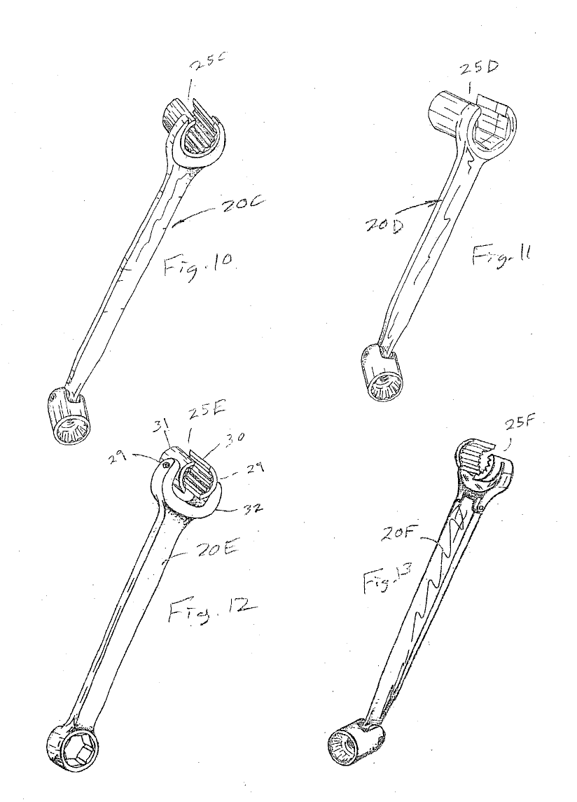

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a locking pliers 1 according to one aspect of the present invention includes first and second handle portions 2 and 3, respectively. The locking pliers 1 include a locking mechanism 4 of a known type that locks first and second jaws 5 and 6, respectively in a closed position. First jaw 5 includes first and second transversely extending sidewalls 7 and 8. Similarly, second jaw 6 includes transversely extending lower sidewalls 9 and 10. The sidewalls 7, 8, 9, and 10 each include a plurality of grooves 6 that form at least a portion of a socket 12 when the jaws 5 and 6 are in the closed position illustrated in FIG. 1. The grooves or teeth 11 each include surfaces 13 forming approximately a one hundred and twenty degree angle to fit closely around the corners of a standard fastener having a hexagonal shape. As illustrated in FIG. 2, the sidewalls 7, 8, 9, and 10 of the locking pliers extend an equal distance from the side faces 14 and 15 of the jaws 5 and 6.

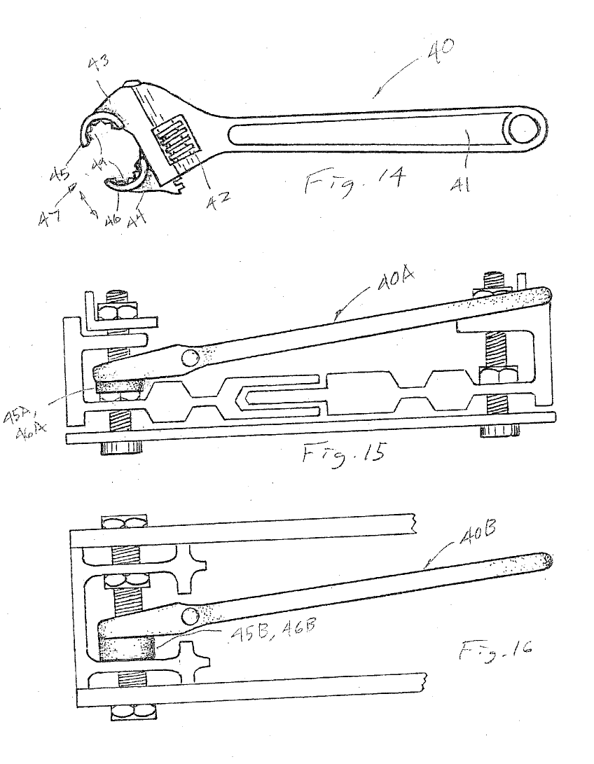

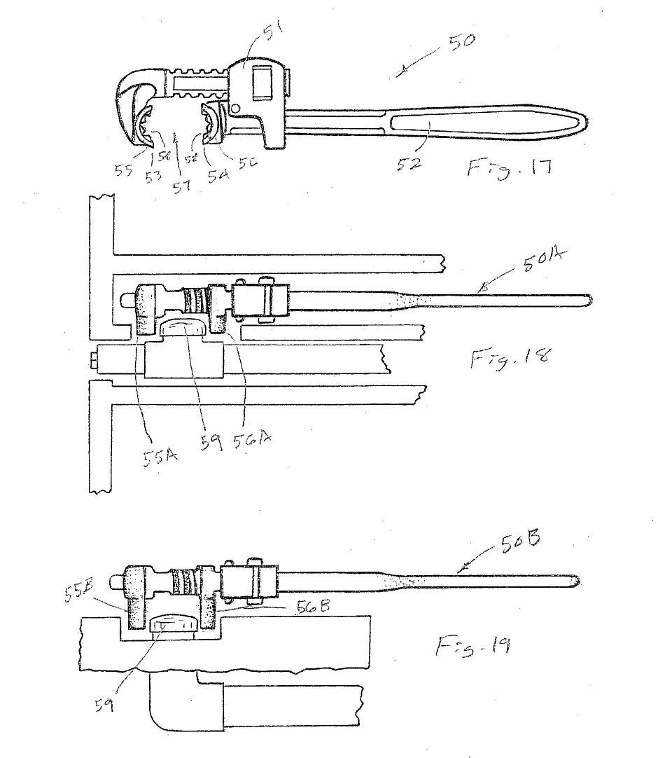

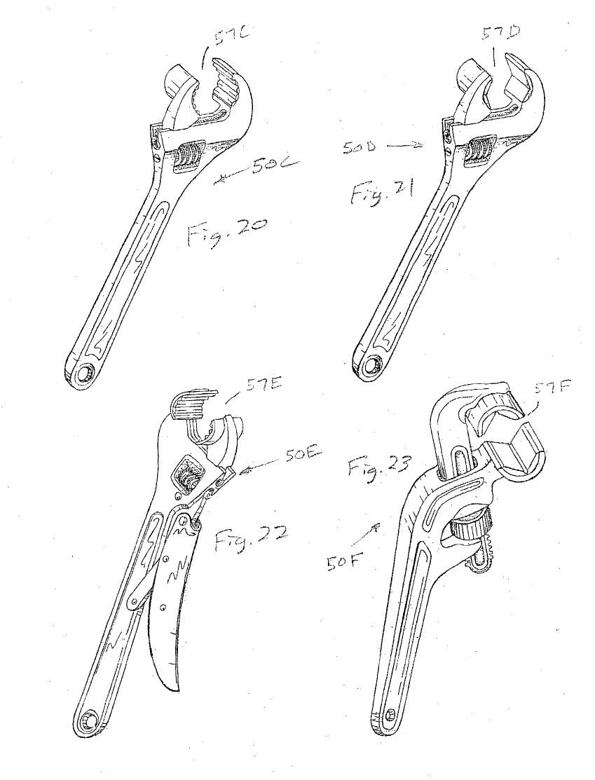

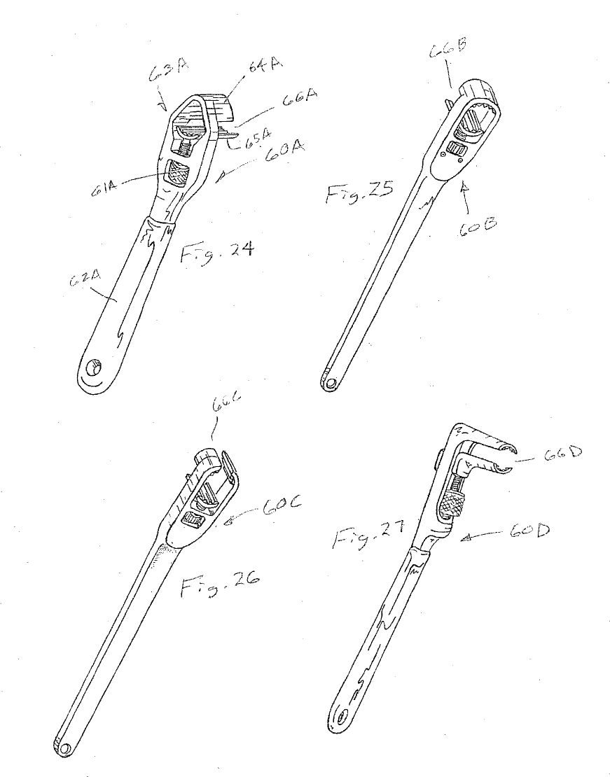

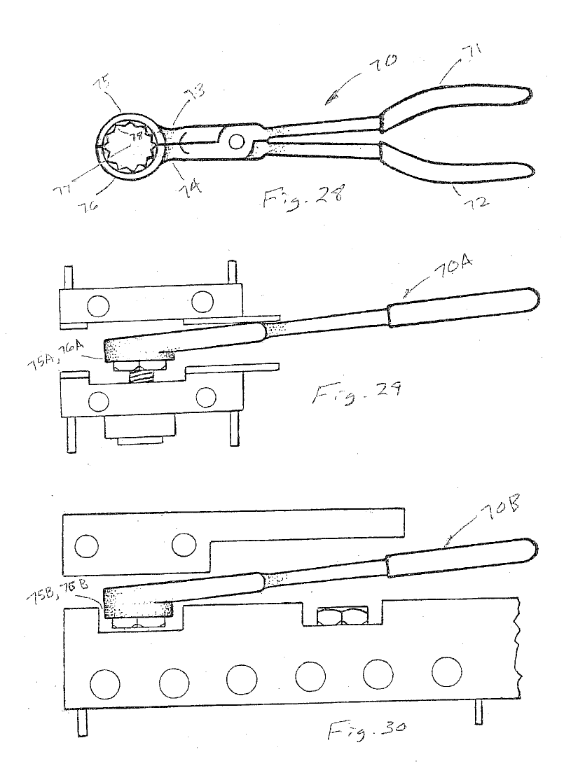

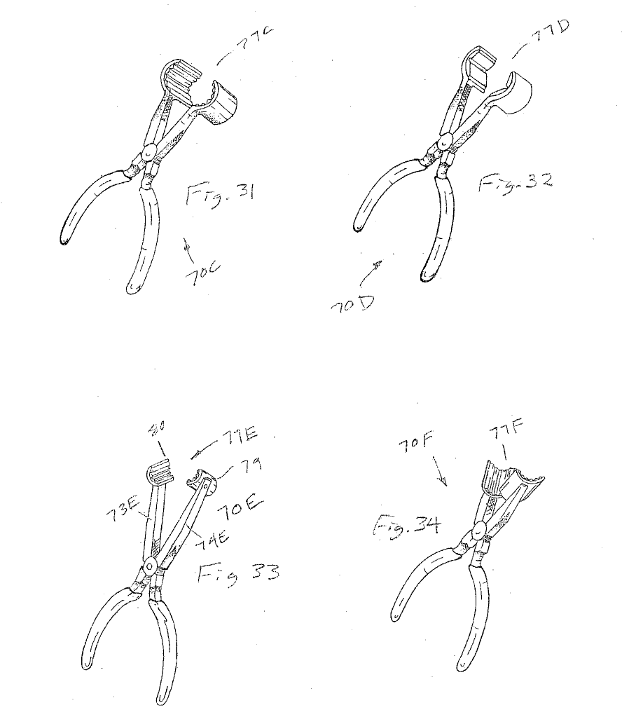

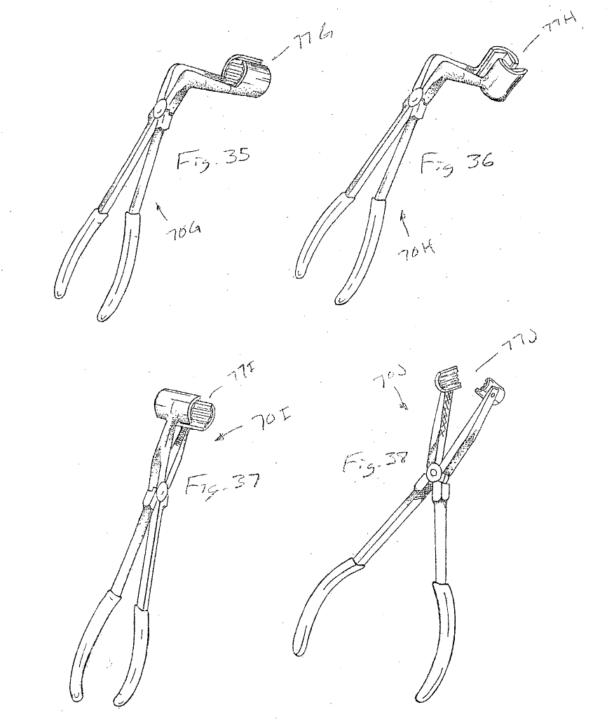

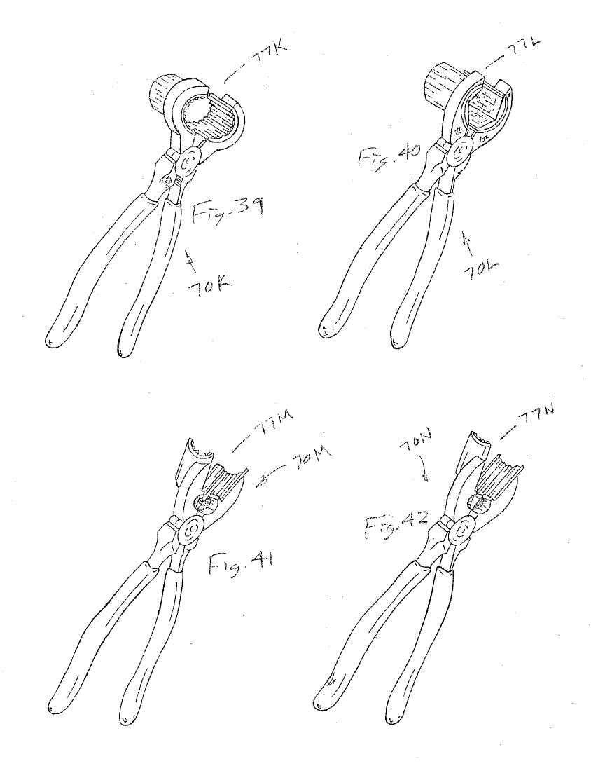

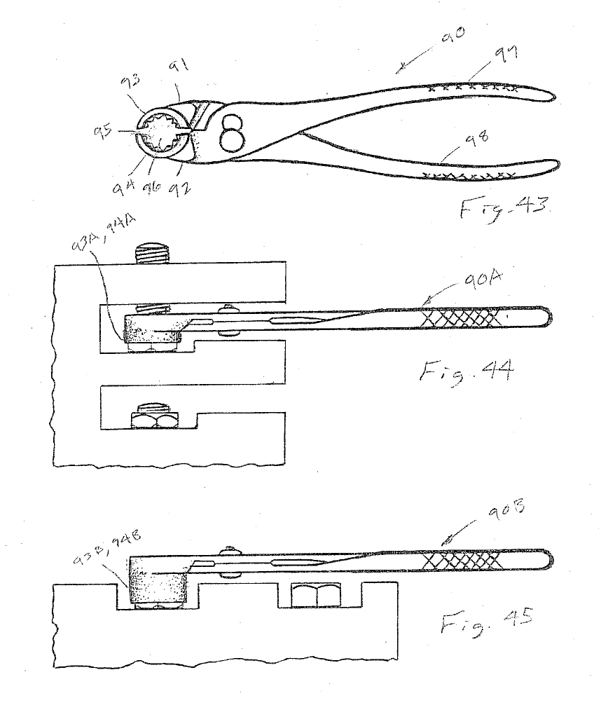

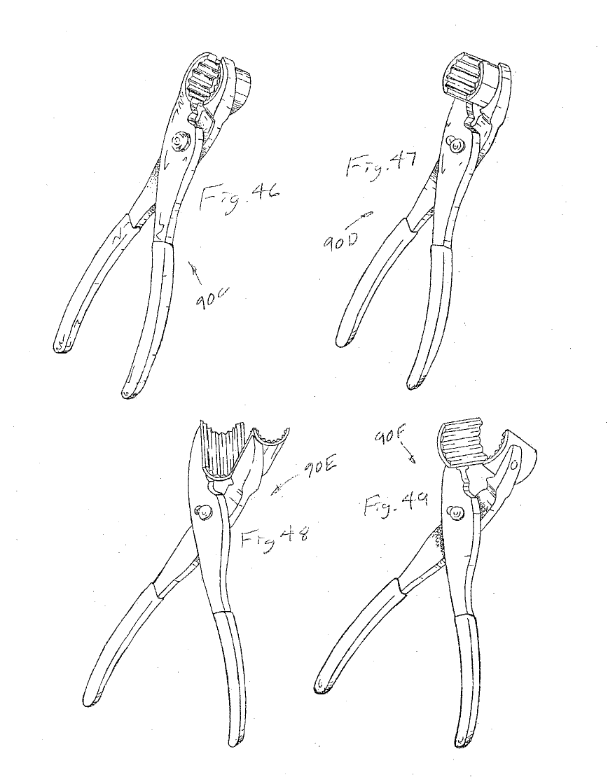

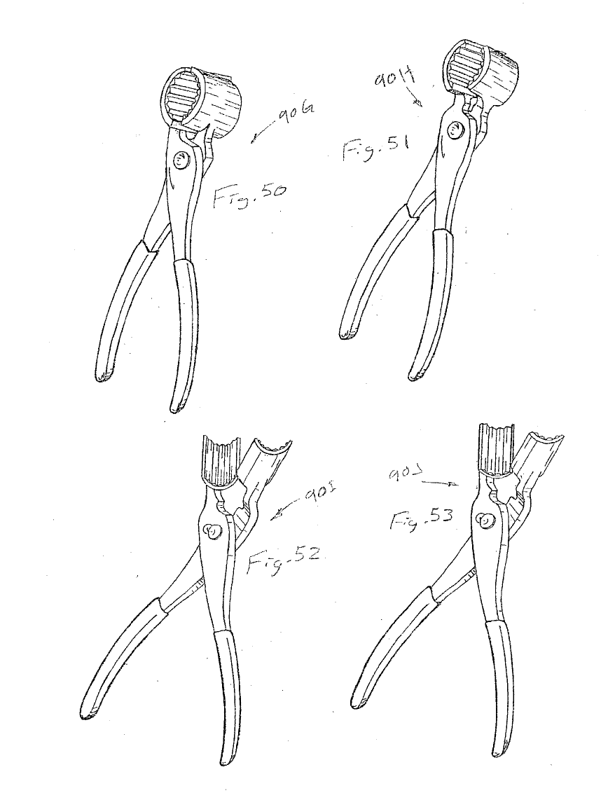

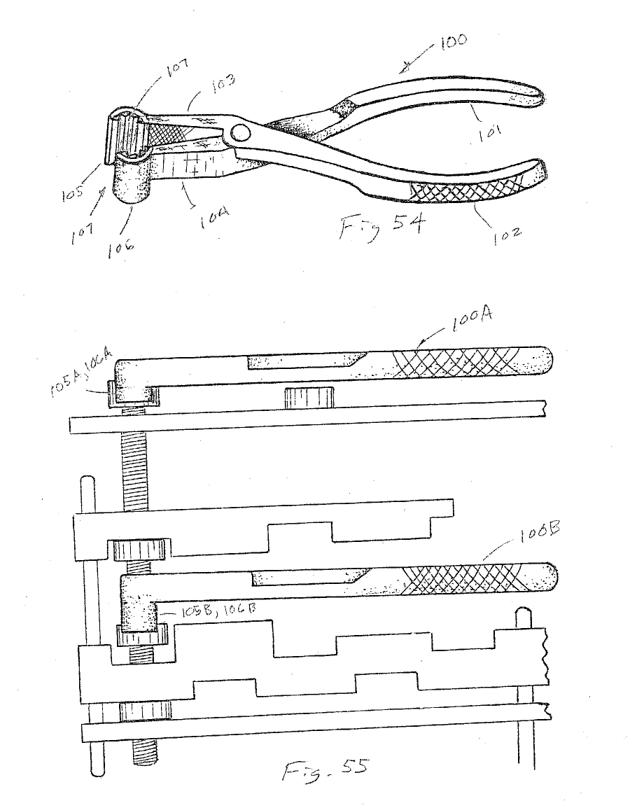

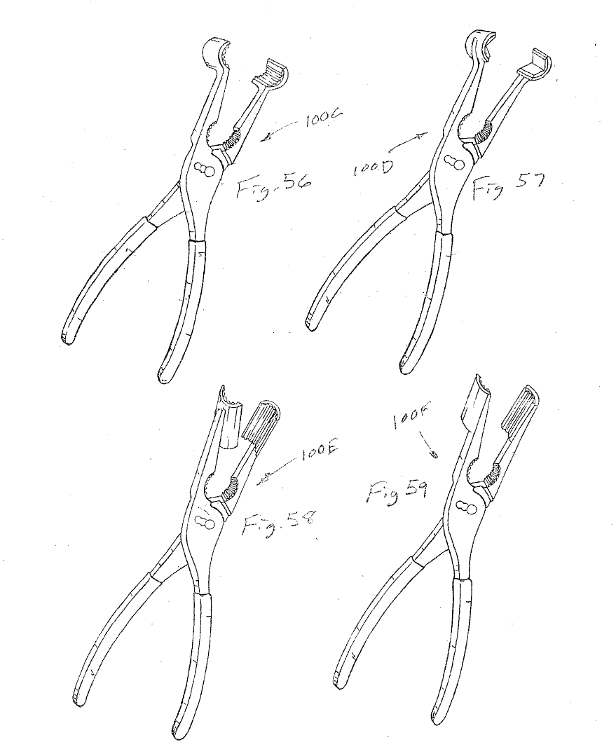

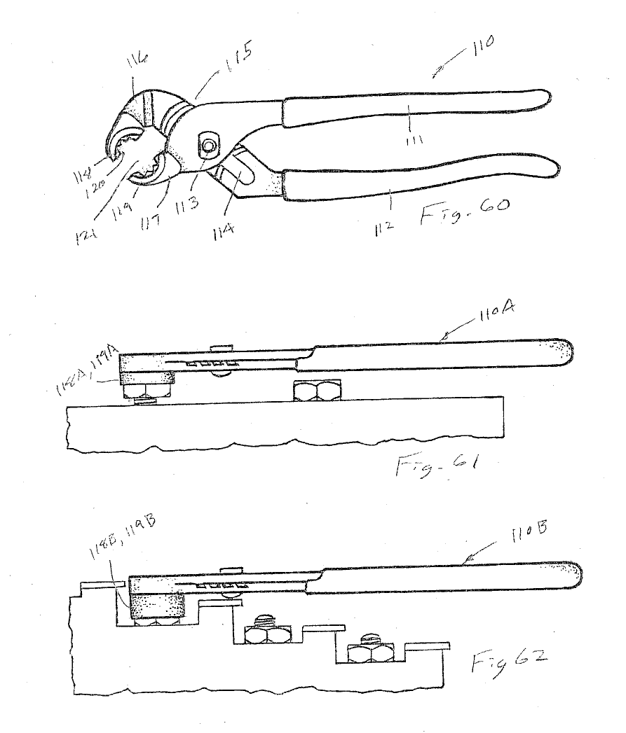

With further reference to FIGS. 3-6, alternate embodiments 1A and 1B of the locking pliers also form sockets 12A and 12B, respectively. However, the sidewalls of the locking pliers 1A do not form a complete semicircle, and therefore form gaps 16A and 17A when in the closed position illustrated in FIG. 3. Furthermore, as seen in FIGS. 4 and 6, the sidewalls may extend further from one side of the jaws than the other, thereby forming a transverse offset socket 12A or 12B. As illustrated in FIG. 5, the sidewalls may form larger gaps 16B and 17B.

With reference to FIG. 7, an open end wrench 20 according to another aspect of the present invention includes a conventional elongated handle portion 21 and a conventional head 22. However, the wrench 20 includes a transversely extending sidewall 23 including a plurality of teeth 24 forming a socket 25 having an opening or gap 26. The opening 26 permits the wrench 20 to be positioned around, for example, a threaded member 27 (FIG. 9) to engage a hex nut 28 or the like. In a preferred embodiment, the sidewall 23 is generally C-shaped in cross section. Alternate embodiments 20A and 20B (FIGS. 8 and 9) of the open end wrench include sidewalls 23A and 23B of different lengths to accommodate different applications as required.

Alternate embodiments 20C, 20D, 20E, and 20F of open end wrenches according to the present invention are illustrated in FIGS. 10-13. Each of the wrenches forms a socket having an opening to permit the wrench to be utilized as discussed above. The wrench 20E includes first and second members 30 and 31 that form a socket 25E. The members 30 and 31 are pivotably mounted to the support 32 of wrench 20E and pivot about the connectors 29.

With reference to FIG. 14, an adjustable open end wrench 40 according to another aspect of the present invention includes a conventional handle 41 and a conventional adjustment mechanism 42. A first jaw 43 is formed integrally with the handle 41, and a second jaw 44 translates to provide adjustment. Jaw 43 includes a transversely extending wall 45, and jaw 44 includes a transversely extending wall 46. The transverse walls 45 and 46 include a plurality of teeth 49, such that the jaws 43 and 44 form a socket 47 configured to grip fasteners having a hexagonal shape. As illustrated in FIGS. 15 and 16, the sidewalls 45A, 46A and 45B, 46B may have various lengths to accommodate various applications.

With further reference to FIG. 17, a wrench 50 includes an adjustment mechanism 51 that is of the type utilized for conventional pipe wrenches. A handle 52 includes a second jaw portion 54, and a first jaw 53 is interconnected to the handle 52 via the adjustment mechanism 51. Jaws 53 and 54 include transversely extending walls 55 and 56 having teeth 58 to form a socket 57 configured to engage fasteners or the like having a hexagonal shape. As illustrated in FIGS. 18 and 19, alternate embodiments 50A and 50B of the wrench may include transverse extensions 55A, 56A, and 55B, 56B to accommodate pipe caps 59 or the like that have limited access thereto. Alternate embodiments 50C, 50D, 50E, and 50F of adjustable wrenches forming sockets 57C, 57D, 57E, and 57F, respectively, are illustrated in FIGS. 20-23. With further reference to FIG. 24, an adjustable wrench 60A includes a handle 62A and an adjustment mechanism 61A of a known type. The head 63A of the wrench includes a first transverse extension 64A that is integrally formed with the head, and a second transverse extension 65A that can be shifted via adjustment mechanism 61A. The extension 64A and 65A together define an adjustable socket 66 that can be utilized to engage fasteners having hex shape. Alternate embodiments according to the present invention are illustrated in FIGS. 25, 26, and 27.

With reference to FIG. 28, a pinch nose pliers 70 according to another aspect of the present invention. Pliers 70 includes jaws 73 and 74 with transverse extensions 75 and 76. The extensions 75 and 76 include a plurality of teeth 78, such that the jaws 73 and 74 form a socket 77 when in the closed position. As illustrated in FIGS. 29 and 30, alternate embodiments 70A and 70B of the pinch nose pliers have transverse extensions 75A, 76A and 75B, 76B of varying lengths to accommodate various applications.

As illustrated in FIGS. 31-42, alternate embodiments of the pliers include various sockets 77C-77N. The pliers 70E of FIG. 33 includes socket members 79 and 80 that are pivotably mounted to the jaws 73E and 74E. As illustrated in FIGS. 41 and 42, sockets 77M and 77N may be oriented generally in line with the handles. With reference to FIG. 43, a pliers 90 according to another aspect of the present invention includes handles 97 and 98, and first and second jaws 91, 92, respectively. Jaws 91 and 92 include transverse extensions 93 and 94, each of which include a plurality of teeth 95 to form a socket 96 when the jaws 91 and 92 are in the closed position. As illustrated in FIGS. 44 and 45, the transverse extensions may have varying lengths for various applications. Alternate embodiments of the pliers are illustrated in FIGS. 46-53.

With reference to FIG. 54, another pliers 100 according to the present invention includes handle portions 101 and 102, and jaws 103 and 104. Transverse extensions 105 and 106 on jaws 103 and 104 each include a plurality of teeth 107 to form a socket 107 when in a closed position. As illustrated in FIG. 55, alternate embodiments 100A and 100B of the pliers includes transverse extensions 105A, 106A, and 105B and 106B for various applications. Alternate embodiments of the pliers are illustrated in FIGS. 56-59.

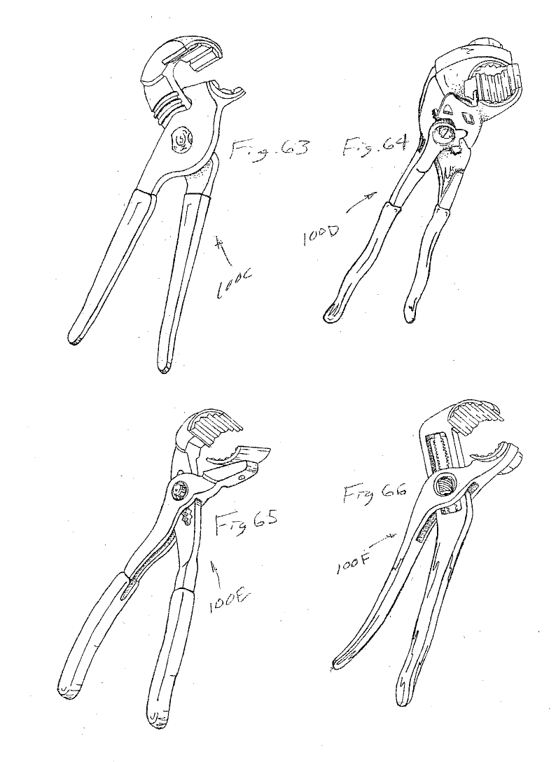

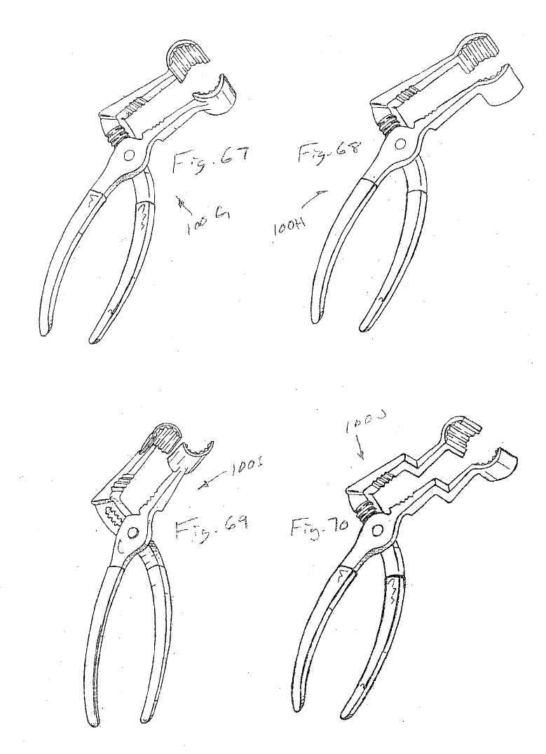

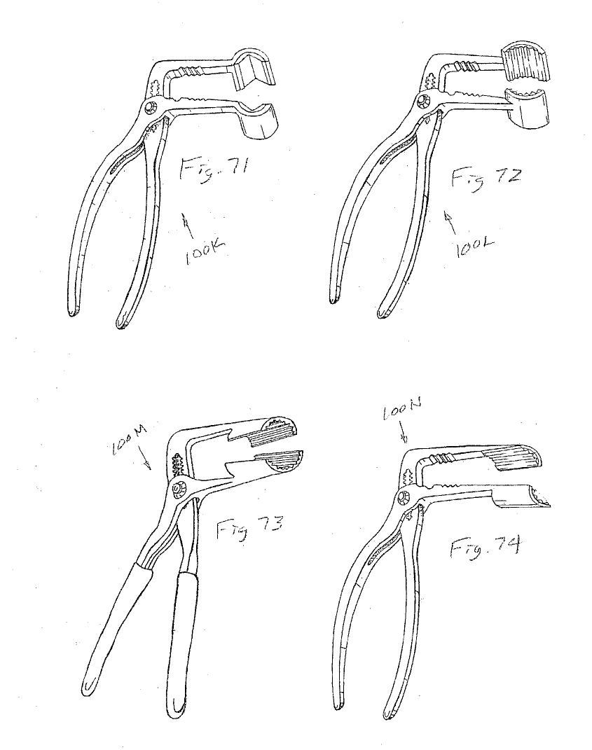

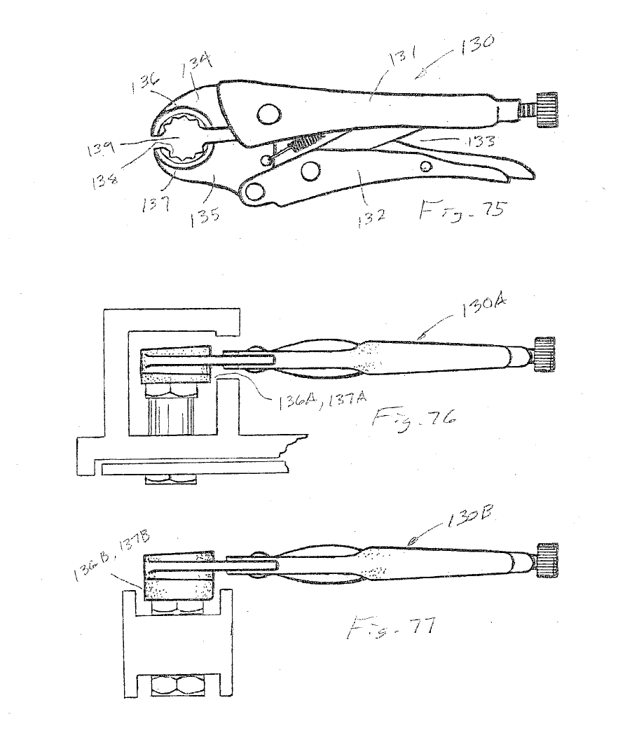

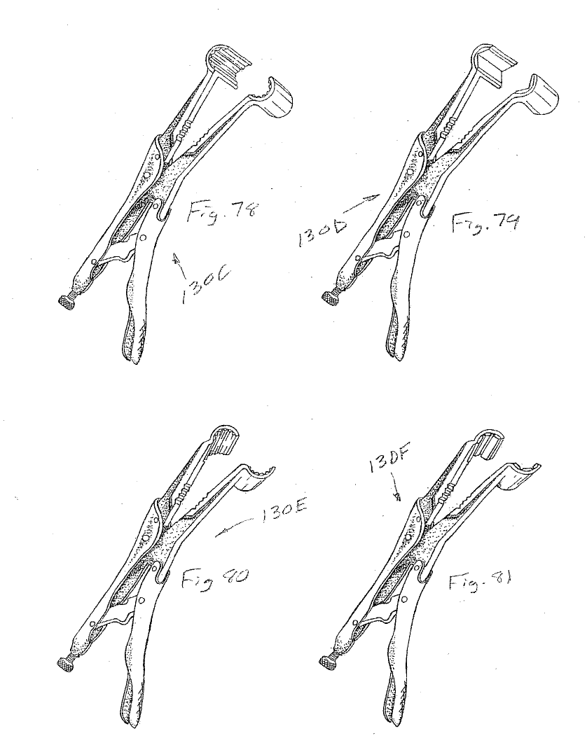

With reference to FIG. 60, an adjustable pliers 110 includes handles 111 and 112. A connector 113 extends through an elongated slot 114 to interconnect the handle portions 111 and 112, and a tongue and groove arrangement 115 provides sliding engagement in a known manner. Jaws 116 and 117 include transverse extensions 118, 119, respectively. The transverse extensions 118 and 119 each include a plurality of teeth 120 forming a socket 121 when the jaws 116 and 117 are in the closed position. As illustrated in FIGS. 61 and 62, transverse extensions 118A, 119A, and 118B, 119B of various lengths may be utilized for various applications. Alternate embodiments of adjustable pliers according to the present invention are illustrated in FIGS. 63-74.

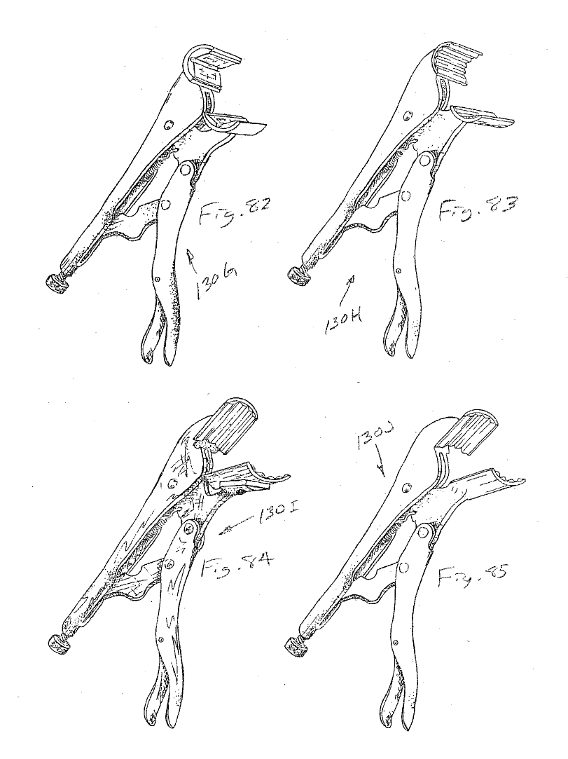

With reference to FIG. 75, a locking pliers 130 according to the present invention includes handle portions 131 and 132 and a locking mechanism 133 that is of a known type. First and second jaws 134, 135, respectively, include transverse extensions 136, 137, respectively. The transverse extensions 136 and 137 each include a plurality of teeth 138 forming a socket 139 when the jaws 134 and 135 are in the closed position. As illustrated in FIGS. 76 and 77, the transverse extensions 136A, 137A and 136B, 137B may have different lengths to accommodate different applications. Alternate embodiments of locking pliers according to the present invention are illustrated in FIGS. 78-85.

The wrenches and pliers according to the present invention form sockets that are offset to provide access to fasteners having hexagonal shapes. The tools can be utilized to grip objects despite limited access space.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A pliers, comprising:
first and second handle members configured to be grasped by a user;
first and second jaws pivotably interconnected with said first and second handle member about a pivot axis and movable to a closed position, said first and second defining engagement gripping surfaces forming at least a portion of a socket when in said closed position, said socket having sidewalls extending generally parallel to said pivot axis.

2. The pliers of claim 1, wherein:
said socket includes a plurality of grooves configured to fit closely around corners of a fastener having a hexagonal cross sectional shape.

3. The pliers of claim 1, wherein:
said pliers includes a locking device that selectively retains said jaws in said closed position.

4. The pliers of claim 1, wherein:
said first and second jaws are formed integrally with said first and second handle member.

5. The pliers of claim 4, wherein:
said first handle member includes an elongated slot and said second handle member includes a pivot member extending through said slot, and wherein:
said slot and second handle members are interconnected by tongues and grooves to provide size adjustment.

6. The pliers of claim 1, wherein:
said sidewalls are pivotably connected to said first and second jaws.

7. A one-piece open end wrench, comprising:
a conventional handle adapted to be grasped by a user, said handle defining a centerline, and said wrench including an integral head at a first end of said handle, said head including a pair of spaced apart members extending from said first end, said head having a first side face spaced a first distance from said centerline; and including:
a transverse extension wall extending from said head, said extension wall having a generally arcuate cross sectional shape and having an end defining a second side face that is spaced a second distance from said centerline, wherein said second distance is substantially greater than said first distance, said extension wall defining at least a portion of a socket having a plurality of grooves adapted to engage a fastener having a hexagonal shape.

8. The open-end wrench of claim 7, wherein:
said wrench is made of a forged metal material.

9. The open-end wrench of claim 8, wherein:
said head comprises a first head; and including:
a second head at a second end of said handle, said second head having parallel opposite side faces and having a U-shaped profile and defining a thickness that is substantially uniform over the entire U-shaped profile.

10. The open-end wrench of claim 7, wherein:
each groove defines sidewalls forming an angle of one hundred and twenty degrees.

11. The open-end wrench of claim 11, wherein:
said extension wall has a generally C-shaped cross sectional shape.

12. The open-end wrench of claim 11, wherein:
said extension wall has a generally cylindrical outer surface portion.

13. The open-end wrench of claim 12, wherein:
said cylindrical outer surface portion defines a length and a diameter, wherein said length is at least about as great as said diameter.

14. The adjustable open end wrench, comprising:
an elongated member having a conventional handle and a first jaw at a first end, said first jaw having first and second opposite side faces defining a first thickness therebetween, said elongated member including a linear guide;
a second jaw slidably engaging said guide and having first and second opposite side faces that define a second thickness therebetween that is approximately the same as said first thickness;
an adjustment member engaging said second jaw and providing controlled linear translation of said second jaw along said guide to provide variable spacing between said first and second gripping surfaces; and
said first and second jaws each including an extension extending transversely therefrom, said extensions having gripping surfaces including a plurality of elongated parallel grooves forming at least a portion of a socket adapted to engage a fastener having a hexagonal shape.

15. The adjustable open end wrench of claim 14, wherein:
said extensions define sidewalls extending transverse from said side faces.

16. The adjustable open end wrench of claim 15, wherein:
said sidewalls extend outwardly a distance that is substantially greater than said first thickness.

17. The adjustable open end wrench of claim 16, wherein:
said grooves have sidewalls forming an angle of one hundred and twenty degrees therebetween.
